(19) United States
(12) Patent Application Publication
(10) Pub. No.: US 2010/0205087 A1
(43) Pub. Date: Aug. 12, 2010

(54) SYSTEMS AND METHODS TO PROMOTE LOAN REPAYMENT

(75) Inventors: Howard L. Hubler, Rumson, NJ (US); Jason Paul MacRae, New York, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: LOAN VALUE GROUP LLC, Rumson, NJ (US)

(21) Appl. No.: 12/368,521

(22) Filed: Feb. 10, 2009

(51) Int. Cl. G06Q 40/00

(52) U.S. Cl. 705/38

(57) ABSTRACT

Methods and systems permit data management for promoting repayment of loans, such as mortgage loans. In an example embodiment, a remuneration account may be established and associated with a loan or mortgage loan. The remuneration account represents a monetary remuneration amount conditionally payable to a borrower on the loan upon satisfaction of a repayment condition of the loan. Delinquency information representing whether or not the borrower is delinquent on a payment of the loan is monitored. The delinquency information can be associated with the remuneration account value. By examining the delinquency data, all or a portion of the remuneration account value can be released as a function of the examination of the delinquency data by the digital processor, such as by making payment of the remuneration to the borrower upon satisfaction of the repayment condition or cancellation of the remuneration account upon detection of delinquency or default conditions.

### FIELD OF THE TECHNOLOGY

The present technology relates to systems and methods for management of loan related accounts. More specifically, it relates to methods and systems for managing loan accounts to promote repayment of the loan.

### BACKGROUND OF THE TECHNOLOGY

Borrowing money has become a fundamental component of financial life in the United States. For example, most home buyers will take out a mortgage loan to buy a home. In most cases, the loan is secured by the purchased home. Typically, the loan balance will not exceed the value of the home. Thus, a buyer has incentive to make payments on the loan and avoid default so that the lender will not foreclose on the mortgage and thereby take title to the home. However, difficult financial times can have a negative impact on real estate values. During such times, it is possible that a home may be worth less than the outstanding balance on a loan. In some such cases, buyers may default on the loan with a hope of either avoiding liability for the excess of the loan above the value of the real property or renegotiating the loan balance to lower the payments. Lenders or mortgage owners may prefer to have mortgage loans paid off by the borrower because foreclosure may be costly.

Accordingly, it may be desirable to implement methods and systems to promote repayment of loans so as to reduce the incidence of payment delinquency and/or default situations.

### BRIEF DESCRIPTION OF THE DRAWINGS

The present technology is illustrated by way of example, and not by way of limitation, in the figures of the accompanying drawings, in which like reference numerals refer to similar elements including:

FIG. 1 is a conceptual illustration of an embodiment of a system for managing loan remuneration accounts for promoting repayment of loans according to the present technology;

FIG. 2 is a flow chart for an example methodology for managing loan remuneration accounts to promote repayment of loans;

FIG. 3 illustrates components of an example apparatus for processing loan remuneration account related data of the present technology;

FIG. 4 illustrates an example loan remuneration account data structure for a system of the present technology; and

FIG. 5 illustrates components of a networked system for processing or managing remuneration loan accounts of the present technology.

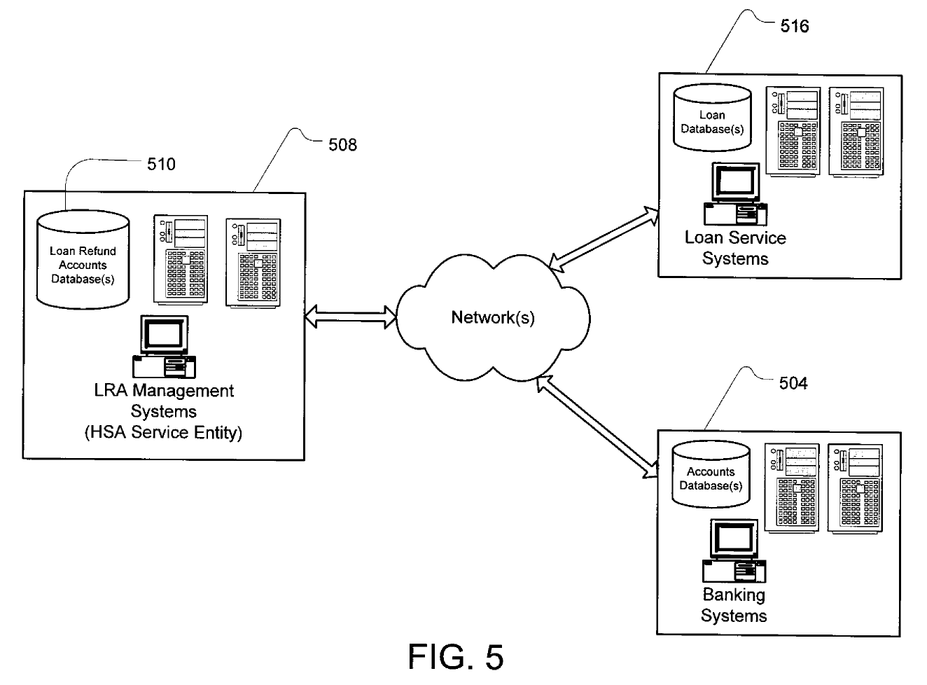

### SUMMARY OF THE TECHNOLOGY

One aspect of the present technology involves methods such as computer implemented methods and systems to manage promoting of repayment of loans or mortgage loans. In such a method, a remuneration account value may be established and/or associated with a mortgage loan. The remuneration account value represents a monetary remuneration amount conditionally payable to a borrower on the mortgage loan upon satisfaction of a payment condition associated with the mortgage loan. Delinquency data that represents whether or not the borrower is delinquent on a payment of the mortgage loan is monitored. The delinquency data can also be associated with the remuneration account value. The delinquency data may then be examined by a digital processor or computer and at least a portion of the remuneration account value may be released as a function of the examination of the delinquency data by the digital processor or computer.

In some embodiments, the releasing involves crediting at least a portion of the remuneration account value to a financial account of the borrower when the delinquency data represents that the borrower has not been delinquent on a payment of the mortgage loan and the borrower has satisfied the payment condition. In still further embodiments, the payment condition comprises full repayment of principal and interest due on the mortgage loan and the crediting comprises a transfer of all of the remuneration account value to the borrower. In some embodiments, the payment condition comprises completion of a particular principal or interest payment of the mortgage loan.

In some methods of the technology, the releasing may involve cancelling the remuneration account value when the delinquency data represents that the borrower has been delinquent on a payment of the mortgage loan. Alternatively, the releasing may involve cancelling the remuneration account value when the delinquency data represents that the borrower has been delinquent on a payment of the mortgage loan and the borrower has not satisfied the repayment condition during a grace period. In still further embodiments, the releasing may involve crediting at least a portion of the remuneration account value to a financial account of the borrower when the delinquency data represents that the borrower has been delinquent on a payment of the mortgage loan and the borrower has satisfied the payment condition during a grace period.

In some embodiments of the method, a digital processor is used to increase the remuneration account value as a function of increase data. The increase data may be an increase amount for the remuneration account value conditioned on a status of the delinquency data. The increasing may occur periodically during a term of the loan or mortgage loan. The method may also involve periodically crediting a financial account of the borrower as a function of a monetary amount during a term of the mortgage loan, the crediting being conditioned on a status of the delinquency data. Optionally, the remuneration account value may be a savings account and the method may also involve receiving an initial deposit for the savings account from a sponsor entity. Moreover, periodic deposits may be received for the savings account from a sponsor entity during a term of the mortgage loan as a condition of the delinquency data.

Any one or more of the aforementioned features of the methods may also be implemented in a computerized system for promoting repayment of a mortgage loan. Such a system may include a database having a loan remuneration account value. The loan remuneration account value can be associated with a mortgage loan and it can represent a loan remuneration amount payable to a borrower on the mortgage loan upon satisfaction of a repayment condition of the mortgage loan. The system may also include a database having delinquency data representing whether or not the borrower is delinquent on a payment of the mortgage loan. The delinquency data can also be associated in the database with the remuneration account value. In the system, a computer readable data storage medium, such as a memory, contains processor control instructions for controlling processing of the delinquency data with a digital processor and for controlling releasing of the remuneration account value as a function of the delinquency data.

Any one or more of the aforementioned features of the methods may also be implemented for a computerized system for promoting repayment of a mortgage loan with a machine readable medium. The medium has processor control instructions to control a processor for managing promoting of repayment of a mortgage loan. The medium may also include processor control instructions for associating a remuneration account value with a mortgage loan where the remuneration account value represents a remuneration amount payable to a borrower on the mortgage loan upon satisfaction of a repayment condition of the mortgage loan. The medium may also include processor control instructions for monitoring delinquency data that represents whether or not the borrower is delinquent on a principal and interest payment of the mortgage loan. This delinquency data may be associated with the remuneration account value. The medium may also include processor control instructions for examining the delinquency data and for releasing the remuneration account value as a function of the examination of the delinquency data.

Further embodiments and features of the technology will be apparent from the following detailed disclosure, abstract, drawings and the claims.

### DETAILED DESCRIPTION

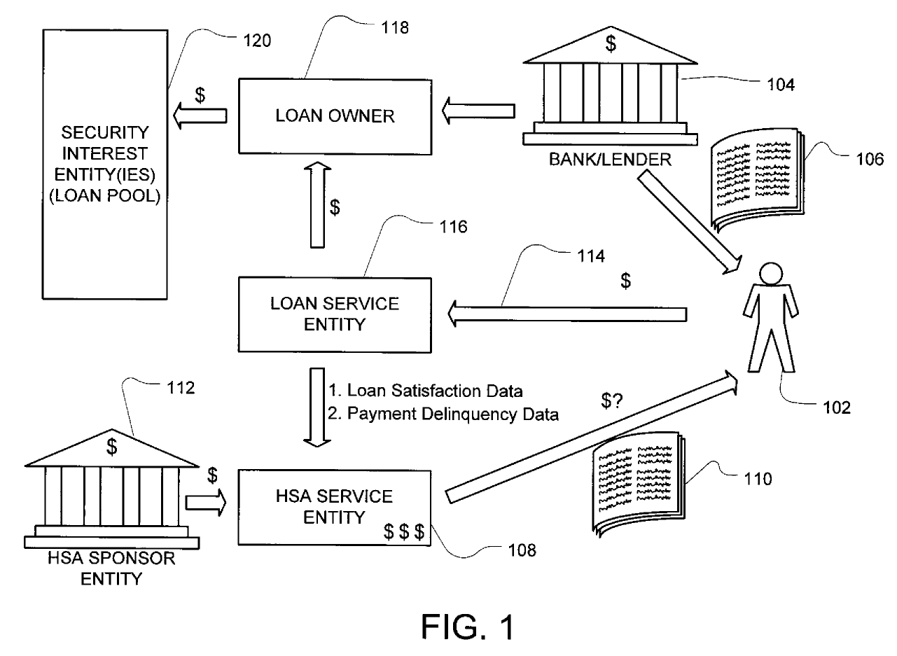

An example implementation of the present technology for managing loan repayment promotion with loan remuneration accounts is illustrated in FIG. 1. Typically, a borrower 102, which may be a mortgagor in the case of a mortgage loan, takes a loan 106 from a bank or lender 104. The loan may obligate the borrower to make periodic principal and/or interest payments 114 during the term of the loan 106. Optionally, the periodic loan payments may be made to a loan service entity 116 which manages the payments made by the borrower. Thus, the loan service entity 116 and/or lender 104 will keep track of a payment schedule of the borrower's loan and the payments made to ensure that the loan payments 114 are being made in a timely fashion. In some cases, proceeds related to the payments of the borrower may be forwarded, in whole or in part, to a loan owner 118 and/or to security interest entities 120 in the event that the loan has been sold or otherwise securitized. Typically, in order to avoid default, the borrower 102 will make payments until the loan is paid off over time or will otherwise satisfy the loan obligation by paying off the full balance of the loan in advance of the scheduled term.

To provide additional incentive to the borrower 102 to stay current (e.g., avoid payment delinquency) in the payments of the loan and/or to pay off the loan in full, an HSA service entity 108 may establish a loan remuneration account (also called a “Homeowner's Savings Account™”) such as by using a savings account. The account may optionally be established at the inception of the loan or at some other time during the term of the loan. Optionally, the loan remuneration account may be based on a separate loan remuneration agreement 110 or may be incorporated as part of a loan agreement or loan instrument. Typically, such an agreement 110 may include a set of conditions upon which a portion or the whole of the account value or balance of the loan remuneration account managed by the HSA service entity 108 can be released (e.g., canceled or distributed).

In the example embodiment of FIG. 1, an HSA sponsor 112 may optionally be obligated or responsible for funding the proceeds of the loan remuneration account managed by the HSA service entity 108. As explained in more detail herein, this funding by the HSA sponsor 112 may be effected when the account is established, during the term of the account and/or at a time of distribution of funds from the loan remuneration account. In some embodiments, the amount of the funds for any given remuneration account may optionally depend on any of the size of the loan, the value of an asset that serves as a security for the loan, and/or the size of the loan payments that will be made during the future term of the loan according to the loan payment schedule. Thus, although the remuneration provided by distributions from the account is based on a borrower's past payment behavior on the loan, the funding source for the payments that conditionally may be distributed to a borrower from the remuneration account would typically originate from a party other than the borrower. Such an originating source of the value or balance for the remuneration account may even optionally be distinct from the lender or loan owner.

Accordingly, in a typical embodiment, an HSA service entity 108 may monitor the conditions of the loan remuneration agreement 110 and the payment status of the borrower's loan to determine (a) when, (b) if and (c) what portion of the loan remuneration account should be released. For example, in some embodiments, some or all of the value of the loan remuneration account may become distributable to the borrower only upon (1) satisfaction of any remaining balance of the loan and (2) if the borrower avoided a delinquency situation during the term of the loan. Optionally, in some embodiments, some or all of the value of the loan remuneration account may become distributable to the borrower if a delinquency situation temporarily existed but if the borrower satisfied the full remaining balance of the loan during a grace period (e.g., a period of months or weeks) where the grace period may optionally begin at a due date for a missed payment and/or after a notice of the delinquency is sent to the borrower. Optionally, in some embodiments, some or all of the value of the loan remuneration account may become distributable to the borrower if a delinquency situation temporarily existed but if the borrower returned to non-delinquent payment status during a grace period (e.g., weeks or days) and the balance of the loan was satisfied (i.e., paid in full) according to the terms of the loan agreement. In some embodiments, the obligation to distribute funds to the borrower of the loan remuneration account may be cancelled or not be required if the borrower is delinquent on one or more loan payments and/or is otherwise in default on the loan. In some embodiments, the obligation to distribute funds of the loan remuneration account to the borrower may be cancelled or not be required if the borrower is delinquent on a loan payment and a grace period has expired without the payment being made and/or without the loan being paid off in full.

In some embodiments, the delinquency situation monitored may be based on determining whether or not the payments that are required/expressed by the original loan agreement/loan payment schedule are timely. Optionally, the delinquency situation monitored may be based on determining whether or not payments required/expressed by a remuneration account agreement are timely where this agreement sets a different payment schedule for the related loan but nevertheless this schedule is still consistent with the schedule of the original loan (e.g., increased payment amounts or frequency). In such embodiments, the original loan would not need to be or would not be re-negotiated or modified in any part. Thus, the payment schedule of the original loan could be satisfied by the different payment schedule set by the remuneration account agreement.

Although FIG. 1 illustrates a single borrower, single loan and single loan remuneration account, it will be understood that the system may be beneficially applied on a larger scale such that the HSA service entity 108 manages loan remuneration accounts associated with many loans and many borrowers. In such a system, the HSA service entity 108 may implement computerized methods for managing and processing data for the loan remuneration accounts (e.g., value balance data) and checking or monitoring the conditions related to the release of the loan remuneration accounts. For example, the HSA service entity 108 may be equipped with computers and/or database systems to maintain loan remuneration account related data. Moreover, as discussed in more detail herein, the computer systems may be programmed for managing and processing necessary data to release the funds of the accounts according to loan status data (e.g., payment delinquency related data, loan satisfaction related data, and/or other data regarding the details of the loans). As illustrated in FIG. 1, this data may optionally be communicated to and/or from a loan service entity 116 or lender, for example, by using electronic data communications over a network.

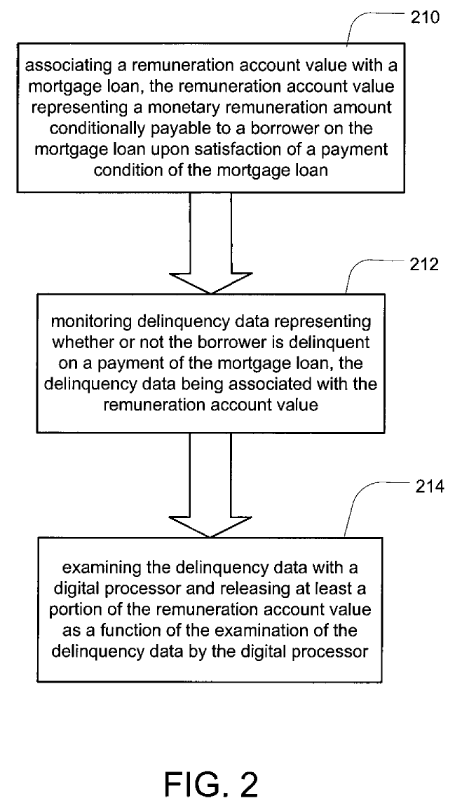

FIG. 2 is a flow chart showing steps or processes for an example embodiment of a methodology for systems of the present technology, such as a computer implemented system. In 210, a remuneration account value is associated with a mortgage loan. The remuneration account value represents a monetary remuneration amount conditionally payable to a borrower on the mortgage loan upon satisfaction of a payment condition of the mortgage loan. In 212, the system monitors delinquency data representing whether or not the borrower is delinquent on a payment of the mortgage loan. The delinquency data will typically be associated with the remuneration account value. In 214, the system can examine the delinquency data with a digital processor, computer or processing device and release at least a portion of the remuneration account value as a function of this examination of the delinquency data by the digital processor, computer or processing device. In some embodiments, the remuneration account balance value will be managed or maintained during the term of the loan by the HSA service entity. For example, memory of the systems of the HSA service entity containing the balance or value data may be adjusted during the term of the loan depending on the conditions of the HSA account agreement 110. These processes may be performed periodically or may execute in response to some manual initiation utilizing one or more user interfaces of the system.

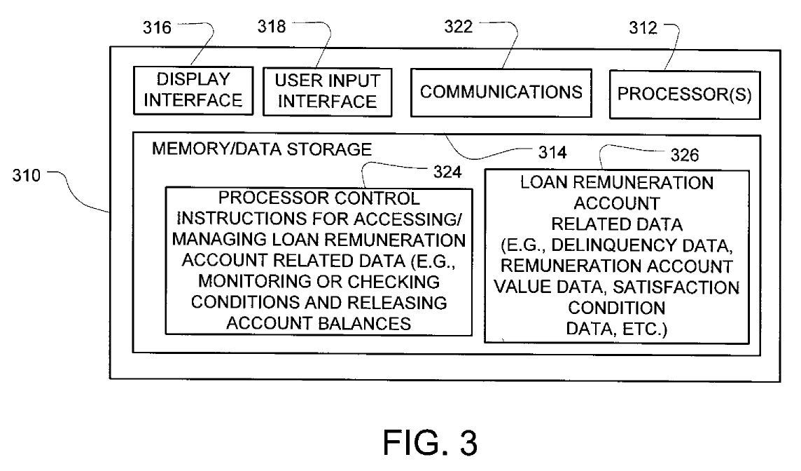

FIG. 3 shows suitable components of an example computerized device for at least these processes in a system of the present technology. The automated methodologies may be implemented with hardware and/or software. For example, FIG. 3 shows components of loan remuneration account management computer 310 that may monitor, process, display or otherwise manage loan remuneration accounts in accordance with the embodiments described herein. The computer may be a general or specific purpose computer with programmable processing control instructions. In the example, computer 310 will typically include one or more processor(s) 312 such as a programmable microprocessor, CPU, DSPs, ASICs, etc. to execute the loan remuneration account processes or algorithms. The computer 310 may also include a display interface 316 for transferring loan remuneration account related data output signals to a display such as an LCD, CRT, plasma, etc. with a viewing screen to show the data. The computer 310 may also include a user input interface 318 to permit a user to access user interfaces of the system to control the computer with a keyboard and/or mouse etc. This can permit manual execution of the processes described here as well as inputting, editing and accessing the loan remuneration account related data. Similarly, the computer may also optionally include other input and output components such as a memory card or memory device interface, magnetic and/or optical drives, communication devices 322 (e.g., a modem, wired or wireless networking device, etc.). These components may permit input and output of loan remuneration account related data for the processes as discussed herein. The communication devices may also optionally permit the computer to act as a server to permit client computers to access the applications and data that constitute user interfaces for the present technology. They may also optionally permit the computer to act as a client to access other servers or databases to obtain or access data for the applications and processes of the present technology.

As further illustrated in the embodiment of FIG. 3, the computer 310 can typically include data and processor control instructions in a memory 314 or data storage that control execution of the functions, methods, algorithms and/or routines as described herein. In some embodiments, these processor control instructions may comprise any set of instructions to be executed directly (such as machine code) or indirectly (such as scripts) by the processor(s). In that regard, the terms “instructions,” “steps”, “algorithm,” “methods” and “programs” may be used interchangeably herein. The instructions may be stored in object code for direct processing by a processor, or in any other computer language including scripts or collections of independent source code modules that are interpreted on demand or compiled in advance.

For example, as illustrated in FIG. 3, the memory 314 can include processor control instructions 324 for managing loan remuneration account related data. These control instructions may also control the automated processes discussed herein. Additionally, the memory may include loan remuneration related data 326.

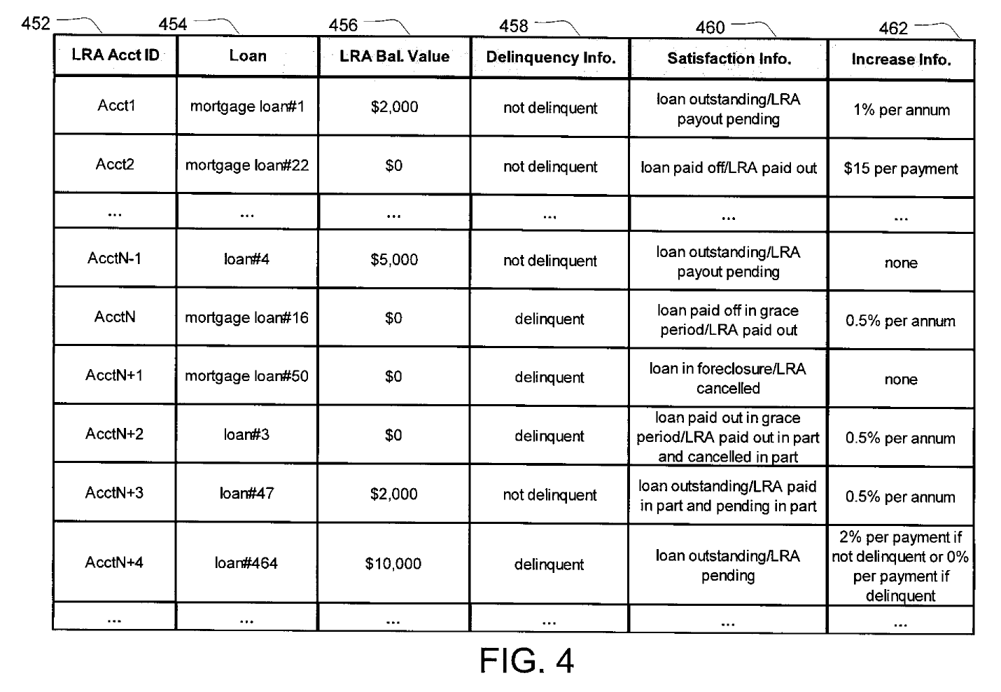

An example data structure with loan remuneration accounts data for an embodiment of a system of the present technology is illustrated in FIG. 4. In a case where the system utilizes a loan remuneration accounts database, a table or tables may be created to maintain a data relationship or association between the loan data and loan remuneration account data so that the value of the loan remuneration account may be released (e.g., cancelled or distributed) in accordance with an automated processing of the rules and conditions associated with cancelling or distributing the value of any particular loan remuneration account in relation to a particular loan and its repayment status. For example, embodiments of the technology may generate a table to a database or other data structure to store or record such data.

In the example of FIG. 4, a table, such as a database table, may optionally include loan remuneration account identification data 452. This may be a unique identifier to distinguish one loan remuneration account from other loan remuneration accounts. Optionally, this may coincide with a unique loan identification number.

In addition, the table may optionally include loan data 452. For example, this may include data (or a pointer or link thereto) that identifies some or all of a loan account number, borrower information data (e.g., name, address, contact, etc.), lender or loan owner information, loan service entity contact information, etc. Optionally, this data may further include loan payment data representing payments made toward the loan, a payment schedule of the loan and/or loan balance data (e.g. principal and/or interest).

In addition, the table may optionally include loan remuneration account balance value data 456. For example, this may include data (or a pointer or link thereto) that identifies a value of a potential remuneration that may be distributable to a borrower as previously described. In an event that the loan account balance has been released in full (either cancelled or paid out), this value may be $0. However, other field data may be optionally utilized, such as remuneration payment value data, to otherwise indicate that the remuneration account value has been released.

In addition, the table may optionally include loan delinquency data 458. For example, this may include data (or a pointer or link thereto) that identifies whether or not a delinquency situation exists or has existed with regard to one or more payments of a loan according to a payment schedule. Such data may also take into account data for any grace period(s) as previously discussed is assessing delinquency. Optionally, this data may be derived from programming logic of software that detects a delinquency situation based on an absence or presence of one or more entered loan payments from loan payment data in comparison with dates (and/or payment amounts) of loan schedule data of a loan of a borrower that identify when payments were/are to be made or of remuneration agreement schedule data of a remuneration account agreement related to the loan of the borrower that identify when payments were/are to be made.

In addition, the table may optionally include loan satisfaction data 460. For example, this may include data (or a pointer or link thereto) that identifies whether or not the loan associated with the loan remuneration account has been paid off, is pending, and/or is in default etc. Such data may also take into account data for any grace period(s) as previously discussed in assessing loan satisfaction. Optionally, this data may be derived from programming logic of software that detects a satisfaction situation based on an absence or presence of one or more entered loan payments from payment data in comparison with dates (and/or payment amounts) of loan schedule data of a loan of a borrower that identify when payments were/are to be made or other data representing a remaining loan balance or of remuneration agreement schedule data of a remuneration account agreement related to the loan of the borrower that identify when payments were/are to be made.

In addition, in some embodiments, the table may optionally include remuneration account increase data 462. For example, this may include data (or a pointer or link thereto) that identifies whether or not and how a loan remuneration account balance value may be increased. For example, in some embodiments, the system may implement changes to loan remuneration account with loan remuneration account increase data. With such data, increases to the balance of the loan remuneration account may be automated. For example, increases may be funded by transfers received from the HSA sponsor entity 112. Such increase data may be utilized to prompt the sponsor entity for the increases or otherwise to simply track an increase of the remuneration account value by the associated increase data. Such increases may be processed to cause the remuneration account value to increase over time during the term of the loan and may be distributable with the balance of the remuneration account as previously described at the satisfaction of the loan. Optionally, such increases may be periodically triggered during the term of the loan and be periodically paid out to the borrower when they accrue during the term of the loan in the absence of a delinquency situation. In such a case, the loan remuneration account balance value may not increase depending on the design logic of the system. However, it may increase pending the processing of a comparable or related periodic payment to the borrower, after which, the value of the remuneration account may be reduced by the amount of the periodic payment.

With such embodiments, automatic or automated processing of loan remuneration accounts may be implemented to process or transfer funds according to the principles of the present technology. For example, FIG. 6 illustrates an embodiment where the system may utilize automated and/or automatic methodologies to promote repayment of loans based on the loan remuneration accounts. In the example, the system is based on the operations of the apparatus of HSA service entity 508 typically having access to one or more loan remuneration account database(s) 510. Periodically, the software of the management computers of the HSA service entity may control one or more processors to request or receive loan related data from a loan database 516 of a loan service system 516 across one or more networks. Such data may reflect a delinquency status and/or satisfaction status of loans managed by the loan service entity 516 with delinquency data or satisfaction data. Alternatively, such data transfers or data entry into the HSA service entity database may be manually initiated. With the software processes of the HSA service, the data of the loan remuneration accounts database may be automatically processed for either one or more accounts to detect whether or not a remuneration payment is due to a borrower based on the loan remuneration account conditions and/or payment status as previously described. This process may be effected by automated processing and examination of at least one or more of associated (a) balance value of a remuneration account, (b) delinquency data, (c) satisfaction data and/or (d) increase data. The process(es) may then generate a report of the remuneration accounts of the database 510 that require increases and/or releases (in part or in full) by either cancellation or distribution of remuneration payments to one or more borrowers. This process may be activated manually by a user or may be triggered by an automatic scheduling process.

Based on the report, payments may then be automatically generated at the service entity and the account values adjusted accordingly. For example, one or more computers may automate the printing of checks for distributing loan remuneration payments to borrowers. Alternatively, the HSA service entity may generate notices and/or electronic communications to some other entity to generate such a check or payment for the borrower. Alternatively, or in addition to, loan remuneration payments may be processed as electronic funds transfers with one or more banking systems 504. Furthermore, in the event remuneration payments or detected increases require deposits into the loan remuneration accounts of the HSA service entity 510 from one or more sponsor entities, electronic funds transfers may be automatically scheduled and/or requested based on the generated report. For example, printed or electronic communication notices may be generated requesting transfer(s) of funds.

Additionally, in some embodiments automated processes of the management systems of the HSA service entity may periodically generate electronic or printed notices for delivery to borrowers to identify the status of their loan remuneration account. Such notices may identify the current balance value of the account and/or the status of their delinquency state (e.g., not delinquent or delinquent). It may also identify the changes to the loan remuneration account during a period of time such as identifying any distributions and/or increases of the account. For example, reminder notices may be generated to inform a delinquent borrower that he or she is in a grace period if a grace period applies due to a delinquency situation detected by an automated examination of delinquency data in the computer system. Such a reminder notice may optionally identify when the remuneration account may be cancelled and/or what action is necessary to preserve their ability to receive a distribution(s) of all or part of the loan remuneration account during a grace period. Thus, the notice may identify for example, any of the conditions previously mentioned that would be necessary for obtaining distributions or it may identify the conditions that resulted in cancellation of the account. Such notices may also optionally be generated for delivery to one or more sponsor entities.

Typical embodiments of the present technology may be implemented to achieve beneficial advantages. For example, loan remuneration accounts as implemented herein have the potential to generate significant gains for loan owners by promoting loan compliance by participating borrowers. Compliant borrowers can qualify to receive remunerations while delinquent or defaulting borrowers may not. If it impedes defaults and/or increases loan payments, then costs for the system can be outweighed by its benefits in increasing present value of outstanding loans. In general, the system helps to align the interests of the borrowers or home owners and the lenders or loan owners in a positive way because it creates incentive for consumers not to default. Unlike other systems for restructuring a debt/loan, the present system does not reward borrowers who eventually default. It is fairer and less expensive than restructuring the debt/loan. Moreover, the present system does not require a modification of the debt/loan. Thus, the system may be more easily applicable to loans or mortgages that have been securitized.

In the foregoing description and in the accompanying drawings, specific terminology and drawing symbols are set forth to provide a thorough understanding of the present technology. In some instances, the terminology and symbols may imply specific details that are not required to practice the technology.

Moreover, although the technology herein has been described with reference to particular embodiments, it is to be understood that these embodiments are merely illustrative of the principles and applications of the technology. It is therefore to be understood that numerous modifications may be made to the illustrative embodiments and that other arrangements may be devised without departing from the spirit and scope of the technology. For example, while the technology may be applied to mortgage loans, it may also be implemented with other types of loans. Moreover, although a distinct entity may serve as a HSA Service entity, in some embodiments the systems and functions of this entity may be optionally combined with other entities of FIG. 1, such as a loan service entity, sponsor entity, lender, etc.

1. A computer-implemented method to manage promoting of repayment of a mortgage loan comprising:
associating a remuneration account value with a mortgage loan, the remuneration account value representing a monetary remuneration amount conditionally payable to a borrower on the mortgage loan upon satisfaction of a payment condition related to the mortgage loan;
monitoring delinquency data representing whether or not the borrower is delinquent on a payment related to the mortgage loan, the delinquency data being associated with the remuneration account value; and
examining the delinquency data with a digital processor and releasing at least a portion of the remuneration account value as a function of the examination of the delinquency data by the digital processor.

2. The method of claim 1 wherein the releasing comprises crediting at least a portion of the remuneration account value to a financial account of the borrower when the delinquency data represents that the borrower has not been delinquent on a payment of the mortgage loan and the borrower has satisfied the payment condition.

3. The method of claim 2 wherein the payment condition comprises full repayment of a principal and interest balance of the mortgage loan and the crediting comprises a transfer of all of the remuneration account value to the borrower.

4. The method of claim 2 wherein the payment condition comprises completion of a particular principal or interest payment of the mortgage loan.

5. The method of claim 1 wherein the releasing comprises cancelling the remuneration account value when the delinquency data represents that the borrower has been delinquent on a payment of the mortgage loan.

6. The method of claim 1 wherein the releasing comprises cancelling the remuneration account value when the delinquency data represents that the borrower has been delinquent on a payment of the mortgage loan and the borrower has not satisfied the payment condition during a grace period.

7. The method of claim 1 wherein the releasing comprises crediting at least a portion of the remuneration account value to a financial account of the borrower when the delinquency data represents that the borrower has been delinquent on a payment of the mortgage loan and the borrower has satisfied the payment condition during a grace period.

8. The method of claim 1 further comprising with a digital processor, increasing the remuneration account value as a function of increase data, the increase data comprising an increase amount for the remuneration account value conditioned on a status of the delinquency data.

9. The method of claim 1 wherein the increasing occurs periodically during a term of the mortgage loan.

10. The method of claim 1 further comprising periodically crediting a financial account of the borrower as a function of a monetary amount during a term of the mortgage loan, the crediting being conditioned on a status of the delinquency data.

11. The method of claim 1 wherein the remuneration account value comprises a savings account and wherein the method further comprises receiving an initial deposit for the savings account from a sponsor entity.

12. The method of claim 11 further comprising receiving periodic deposits for the savings account from a sponsor entity during a term of the mortgage loan as a condition of the delinquency data.

13. A computerized system for promoting repayment of a mortgage loan comprising:
a database including a remuneration account value, the remuneration account value associated with a mortgage loan and representing a remuneration amount payable to a borrower on the mortgage loan upon satisfaction of a payment condition concerning the mortgage loan;
a database including delinquency data representing whether or not the borrower is delinquent on a payment concerning the mortgage loan, the delinquency data being associated with the remuneration account value; and
a computer readable data storage medium containing processor control instructions for controlling processing of the delinquency data with a digital processor and for controlling releasing of the remuneration account value as a function of the delinquency data.

14. The computerized system of claim 13 wherein the releasing comprises crediting at least a portion of the remuneration account value to a financial account of the borrower when the delinquency data represents that the borrower has not been delinquent on a payment of the mortgage loan and the borrower has satisfied the payment condition.

15. The computerized system of claim 14 wherein the payment condition comprises full repayment of a principal and interest balance of the mortgage loan and the crediting comprises a transfer of all of the remuneration account value to the borrower.

16. The computerized system of claim 14 wherein the payment condition comprises completion of a particular principal or interest payment of the mortgage loan.

17. The computerized system of claim 13 wherein the releasing comprises cancelling the remuneration account value when the delinquency data represents that the borrower has been delinquent on a payment of the mortgage loan.

18. The computerized system of claim 13 wherein the releasing comprises cancelling the remuneration account value when the delinquency data represents that the borrower has been delinquent on a payment of the mortgage loan and the borrower has not satisfied the payment condition during a grace period.

19. The computerized system of claim 13 wherein the releasing comprises crediting at least a portion of the remuneration account value to a financial account of the borrower when the delinquency data represents that the borrower has been delinquent on a payment of the mortgage loan and the borrower has satisfied the payment condition during a grace period.

20. The computerized system of claim 13 further comprising a digital processor having a memory with processor control instructions, the processor control instructions to control the processor to increase the remuneration account value as a function of increase data, the increase data comprising an increase amount for the remuneration account value conditioned on a status of the delinquency data.

21. The computerized system of claim 13 wherein the increasing occurs periodically during a term of the mortgage loan.

22. The computerized system of claim 13 further comprising processor control instructions to periodically credit a financial account of the borrower as a function of a monetary amount during a term of the mortgage loan, the crediting being conditioned on a status of the delinquency data.

23. The computerized system of claim 13 wherein the remuneration account value comprises a savings account and wherein the method further comprises processor control instructions to receive an initial deposit for the savings account from a sponsor entity.

24. The computerized system of claim 23 wherein further comprising processor control instructions to receive periodic deposits for the savings account from a sponsor entity during a term of the mortgage loan as a condition of the delinquency data.

25. A machine readable medium having processor control instructions, the processor control instructions to control a processor for managing promoting of repayment of a mortgage loan, the processor control instructions comprising:
processor control instructions for associating a remuneration account value with a mortgage loan, the remuneration account value representing a remuneration amount payable to a borrower on the mortgage loan upon satisfaction of a payment condition relating to the mortgage loan;
processor control instructions for monitoring delinquency data representing whether or not the borrower is delinquent on a principal and interest payment relating to the mortgage loan, the delinquency data being associated with the remuneration account value; and
processor control instructions for examining the delinquency data and for releasing the remuneration account value as a function of the examination of the delinquency data.

26. The medium of claim 25 wherein the releasing comprises crediting at least a portion of the remuneration account value to a financial account of the borrower when the delinquency data represents that the borrower has not been delinquent on a payment of the mortgage loan and the borrower has satisfied the payment condition.

27. The medium of claim 26 wherein the payment condition comprises full repayment of a principal and interest balance of the mortgage loan and the crediting comprises a transfer of all of the remuneration account value to the borrower.

28. The medium of claim 26 wherein the payment condition comprises completion of a particular principal or interest payment of the mortgage loan.

29. The medium of claim 25 wherein the releasing comprises cancelling the remuneration account value when the delinquency data represents that the borrower has been delinquent on a payment of the mortgage loan.

30. The medium of claim 25 wherein the releasing comprises cancelling the remuneration account value when the delinquency data represents that the borrower has been delinquent on a payment of the mortgage loan and the borrower has not satisfied the payment condition during a grace period.

31. The medium of claim 25 wherein the releasing comprises crediting at least a portion of the remuneration account value to a financial account of the borrower when the delinquency data represents that the borrower has been delinquent on a payment of the mortgage loan and the borrower has satisfied the payment condition during a grace period.

32. The medium of claim 25 further comprising with a digital processor, increasing the remuneration account value as a function of increase data, the increase data comprising an increase amount for the remuneration account value conditioned on a status of the delinquency data.

33. The medium of claim 25 wherein the increasing occurs periodically during a term of the mortgage loan.

34. The medium of claim 25 further comprising periodically crediting a financial account of the borrower as a function of a monetary amount during a term of the mortgage loan, the crediting being conditioned on a status of the delinquency data.

35. The medium of claim 25 wherein the remuneration account value comprises a savings account and wherein the method further comprises receiving an initial deposit for the savings account from a sponsor entity.

36. The medium of claim 35 wherein further comprising receiving an periodic deposits for the savings account from a sponsor entity during a term of the mortgage loan as a condition of the delinquency data.
